(19) United States
(12) Patent Application Publication
(10) Pub. No.: US 2017/0089599 A1
(43) Pub. Date: Mar. 30, 2017

(54) USING WIRELESS HVAC DAMPERS FOR INTERNET OF THINGS END-POINT SENSING, MONITORING, CONTROL AND RESPONSE WITHIN BUILDINGS

(71) Applicant: Larry D. Hale, Campbell, CA (US)

(72) Inventor: Larry D. Hale, Campbell, CA (US)

(73) Assignee: Larry D. Hale, Campobell, CA (US)

(21) Appl. No.: 15/212,244

(22) Filed: Jul. 17, 2016

Related U.S. Application Data
(60) Provisional application No. 62/194,617, filed on Jul. 20, 2015.

(51) Int. Cl. F24F 11/00; H04W 4/00; G05B 19/048; H04L 12/28

(52) U.S. Cl. CPC F24F 11/006; H04L 12/2814; H04W 4/001; G05B 19/048; H04W 84/18

(57) ABSTRACT

The invention will facilitate the creation of a wireless mesh network based upon a plurality of wireless dampers used in HVAC (Heating, Ventilation and Air Conditioning) for the purposes of sensing, controlling and responding to environmental and security devices or control fixtures within a building. Each building fixture includes a communication port and a controller. Each controller is configured to independently control at least one of an environmental or security device, either receive or help designate the building fixture as belonging to a group of building fixtures and propagate sensor and state information through the logical groupings of building fixtures and through the wireless mesh network via the communication port to a logical group control fixture that also operates as a floor-level wireless mesh network access point, end point control fixture controller message relayer and initiator of autonomous functions, information aggregator and disseminator.

### REFERENCES CITED

The present applications claims priority to the earlier filed provisional application having application Ser. No. 62/194,617, and hereby incorporates subject matter of the provisional application in its entirety.

### FIELD OF THE EMBODIMENTS

The described embodiments relate generally to building monitoring, controls and their responses. More particularly, the described embodiments relate to logical groupings of intelligent building fixtures for controlling HVAC (Heating, Ventilation and Air Conditioning), the building environment, building security, fire control and an end-point connection with the Internet of Things and network connected fixtures within buildings.

### BACKGROUND

Building control systems are continually being developed and being integrated into the Internet (as part of the “Internet of Things”, abbreviated as IoT). Building control systems can provide intelligence within a building or structure for improving energy use, occupant comfort and building security. The complexity of buildings and their control systems have evolved to automated systems with central points of control within the building, a complex of buildings or decentralized via internet control. The most common building control and monitoring systems provide control and monitoring of lighting, HVAC, fire control and security.

The advent of intelligent HVAC (Heating, Ventilation and Air Conditioning) systems in buildings has led to emplacing wired and wireless sensors and intelligent controls throughout building systems in new construction and retrofit upgrades. Air handlers, economizers, heat exchangers, VAV boxes (Variable Air Volume) and the like are typically integrated together in a system containing heterogeneous equipment and systems for facilities management. All HVAC equipment is typically integrated except for one area: the end-point air delivery ducting typically consisting of simple air damper units or one employing wired damper units.

It is desirable for buildings employing wireless dampers as end-point HVAC air delivery units to be logically grouped together for building zone control purposes and to further utilize the wireless dampers in an intra-building scalable and configurable wireless mesh network that communicates and controls wireless fixtures orchestrating lighting, HVAC, fire control and security.

### SUMMARY OF THE INVENTION

The invention will facilitate the creation of a wireless mesh network based upon a plurality of wireless dampers used in HVAC (Heating, Ventilation and Air Conditioning) for the purposes of sensing, controlling and responding to environmental and security devices or apparatuses (end point control fixtures) within a building. Further, each building fixture includes a communication port and a controller. For this embodiment, each controller is configured to independently control at least one of an environmental or security device, either receive or help designate the building fixture as belonging to a group of building fixtures and propagate sensor and state information through the logical groupings of building fixtures and through the wireless mesh network via the communication port to a logical group control fixture that also operates as a floor-level wireless mesh network access point, end point control fixture controller message relayer and initiator of autonomous functions, information aggregator and disseminator.

Another embodiment includes utilizing the robust and self-healing network communications of a wireless mesh network to aid in circumventing building obstructions such as walls, metalwork, installed equipment and EMI (electromagnetic interference) within the building.

Another embodiment includes a method of operating a building end point control fixture as a floor-level logical group control fixture. The method includes designating a building end point control fixture as belonging to a logical group of building fixtures, wherein the designating includes at least one of receiving the designation or the building fixture aiding in the designation, independently controlling, by the building end point control fixture, at least one of an environmental or security device, and sharing, by the building end point control fixtute, and propagating sensor and state information through the logical groupings of building fixtures and through the wireless mesh network via the communication port to the logical group control fixture.

Another embodiment includes a method of using an end point control fixture to suffice as a master control fixture for a building whose purpose is to control and respond to each logical group control fixture and end point control fixture within the building and to suffice as an external internet access point for accessing all floor-level wireless mesh access points (logical group control fixtures) comprising the building's wireless mesh network.

The embodiments of a building-level master control fixture and a floor-level local group control fixture are similar to an end point control fixture with the exception of intended functions. Both of these control fixture types can be allowed to connect directly to or wirelessly to a building environmental, fire control or security fixture for the purposes of sensing, controlling and responding.

Another embodiment includes the ability to access hetereogenous wireless end point control fixtures found within the occupant-used spaces of a building as a method allowing these fixtures to gain access to or expand upon the wireless mesh network established by the wireless dampers or third party vendor's wireless mesh networks. Logically, this is accomplished by all nodes being communications-compatible.

Another embodiment includes a method of using industry-established TAB ((air) Test, Adjustment & Balancing) techniques to perform autonomous air flow balancing in a logical grouping (an HVAC zone), whereby an adjustment to a selected end point control fixture may possibly affect the pre-configured environment of another end point control fixture within the logical grouping, causing one or more end point control fixtures within the logical grouping to autonomously compensate to their original environmental configuration.

Another embodiment includes a method of using a wireless mesh network based upon a plurality of wireless dampers within a building or plurality of buildings having similar wireless mesh networks, externally connected to the Internet to serve as an IoT (Internet of Things) terminus for sensing, controlling and responding to selected logical groupings or individual end point control fixtures.

Another embodiment includes a method of using an end point control fixture to initiate communication through the IoT (Internet of Things) incorporating the wireless mesh network for purposes of sending information about an event (such as a deleterious environment scenario or security breach) to a recipient Internet receiving agent (such as a web server application, either within the wireless mesh network or remotely across the Internet).

Another embodiment includes a method of using a wireless mesh network based upon a plurality of wireless dampers within a building or plurality of buildings having similar wireless mesh networks, externally connected to the Internet to serve as an offsite mechanism for performing OTA (Over the Air) wireless damper software updates to an end point control fixture or a plurality of end point control fixtures. Additionally, a computing device internally connected to the wireless mesh network can initiate and coordinate an OTA update.

Another embodiment includes a method of integrating an end point control fixture to a BMS (Building Management System) and/or BAS (Building Automation System) to suffice as a gateway between the wireless mesh network and legacy building management systems, which might manage one or a plurality of buildings having or sharing a wireless mesh network.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a building control system according to an embodiment.

FIG. 2 shows an example of logical groupings of fixtures.

FIG. 3 is a flow chart that includes steps of an example of a method of operating a building control fixture according to an embodiment.

FIG. 4 is an example of the flow of communication between a master control fixture and a chosen end point control fixture.

FIG. 5 is a flow chart describing the autonomic air balancing feature of a zone.

FIG. 6 shows an example of using a building's wireless mesh network to extend the Internet of Things.

FIG. 7 is a flow chart depicting the request and response communications of an IoT agent.

FIG. 8 is a flow chart depicting the normal and abnormal communications between building fixtures and one or more internet recipients.

FIG. 9 is an example of the flow of communication between heterogeneous wireless mesh network nodes (i.e. between wireless damper end points and other vendor's wireless mesh-based end point fixtures).

FIG. 10 is a flow chart describing the process of initiating or receiving control, response, and monitoring messages through the heterogeneous wireless mesh network

### DETAILED DESCRIPTION

The described embodiments are embodied in methods, apparatuses and systems for singular and logical groupings of building fixtures. One embodiment of the fixtures includes environmental control apparatuses, such as wireless end-point dampers for heating, ventilation and air conditioning (HVAC). Embodiments of the building fixtures provide independent intelligent building controls. The intelligence of each individual building fixture can be enhanced through wireless communication with other building fixtures in a logical grouping of the building fixtures. The logical groupings can be designated in one or more ways, and each building fixture of a logical group can utilize information from one or more of the other building fixtures of the logical group. These embodiments allow for easy, efficient building environmental control scaling.

All of the described embodiments provide building control systems that operate with distributed intelligence, moving from a legacy central controlling point to the building fixtures themselves. The wireless damper fixtures typically installed above a ceiling and below the floor or roof above suffice as sensing, monitoring and controlling environment end points collaborating with other end points in logical groupings in a mesh network providing robust, self-healing and scalable end to end communications.

Embodiments of the building fixtures incorporated into the wireless mesh network include devices that are attached to the walls, ceilings and spaces between the ceiling and the floor or roof above of a structure and are used to provide environmental services such as heating, cooling, lighting, fire control or security services such as surveillance or fire protection. Embodiments of the building fixtures can be installed by construction crews in new or retrofitted buildings, but can also be added as required. The most common fixtures are light fixtures, HVAC fixtures, security cameras, or fire alarms and other sensors.

The introduction of low-cost microcontrollers has allowed the control point to be replicated into each fixture along with communications between controllers, so that centralized control points are no longer needed. Two distributed exceptions are the additional functionality provided by a local group control fixture typically used to interface a building's wireless mesh networks to the building's existing communication interfaces, and the other is a master control fixture interfacing all of the building's local group control fixtures. Resiliency compensation for these two exceptions are accomplished by providing redundancy in the network acting as “hot standby” fixtures.

User control points can be provided as required to allow a user to control one or more logical groupings of fixtures. User control points simply communicate with the network of fixtures to provide the necessary sensing, control and monitoring information. Also system administrators and facility managers can manage the building functions by setting up or changing logical groupings of fixtures as required enabling proper system operation. Finally, the networks of the described embodiments provide built-in robustness and redundancy, as networking environment conditions deleteriously change. Failed sensors, network nodes or fixtures can be neutralized and alarmed to keep the fixture network functioning properly.

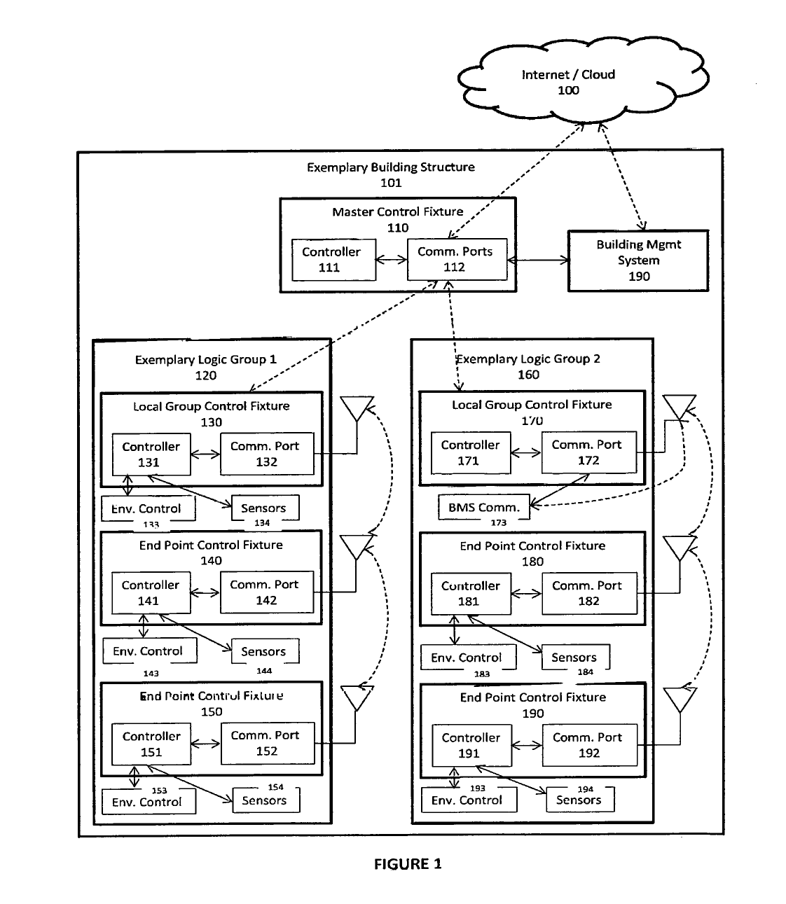

FIG. 1 shows an example of a building control system according to an embodiment. As shown, the building control system includes a plurality of building fixtures 130, 140,150 encapsulated within a logic group 120 located within, for example, a building structure 101. Furthermore, another logical group 160 encapsulates building fixtures 180 and 190, located within the same building structure 101. It is to be understood that the term “building” may be used here to designate or define any structure that may include and benefit from the use of the described building fixtures, such as, any type of indoor room or structure, including, for example, a large convention space. The building control system includes at least one sensor (such as, sensors 134,184) interfaced with at least one of the plurality of building fixtures (such as, building fixtures 130, 180). Additionally, a building fixture can consist of an end point control fixture (such as 140) that can be controlled within a logical group by a local group control fixture (such as 130) who in turn are connected to another building fixture aggregating and communicating with all local groups (like 120, 160) to a master control fixture 110 that is connected to the building's legacy communications network. As shown, all building fixtures 110,130,140,150,170,180,190 each include a controller (such as, controllers 111,131,141,151,171,181,191) and a communication port (such as communication ports 112,132, 142,152,172,182,192) having a wired or wireless (using an antenna) connection.

As will be described, each controller is configured to independently control at least one of an environmental load or a security device. Each controller is configured to either receive or help designate the building fixture as belonging to a logical group of building fixtures (wherein this fixture becomes known as a local group control fixture). Additionally, each controller is configured to share at least one of sensor or state information with other building fixtures within the logical group of building fixtures, through the communication ports.

FIG. 1 shows exemplary logical groups 120, 160. While the logical groupings of FIG. 1 do not overlap (that is, there is not a building fixture shown as belonging to multiple logical groups), embodiments includes building fixtures belonging to one or more logical groups. As will be described, the logical groups can be dynamic and change over time.

At least some embodiments of the building fixtures (also referred to as building control apparatuses) include a device mounted to a wall, a ceiling, or the space between the ceiling and floor/roof above within a building. Embodiments of the building fixtures supply a variety of services including lighting, HVAC, fire control, security and other environmental sensing as needed.

One embodiment of a building fixture includes an intelligent end-point HVAC (Heating, Ventilation and Air Conditioning) wireless damper in collaboration with other end-point wireless dampers. HVAC systems often have multiple dampers in a large room. By controlling the air flow and temperature of air in active areas cooling and heating costs can be reduced. Additionally, by controlling the air flow via the wireless dampers within a logical grouping a balanced laminar flow of conditioned air can be achieved.

Another critical embodiment of an intelligent end-point HVAC wireless damper building fixture is in utilizing its mesh network to self-discover its nearest end-point wireless damper neighbors in a fashion to provide communications robustness to all end point control fixtures. As is typical of mesh networks having autonomous discovery, neighbor proximity and self-healing capabilities, the network achieves high robustness and scalability as more wireless mesh network fixtures are added to the building. The possibility exists that communications traversal across the wireless mesh network spans a plurality of logical groupings.

An embodiment for an end-point wireless damper fixture before it becomes a permanent building fixture includes a calibration mode. After the manufacture of each fixture, the device is powered up and communicated with using a wireless internet agent (such as a browser or mobile application running on a mobile device). The fixture's operating set points are adjusted by a certified tester and become part of the operating state information of the fixture.

An embodiment includes various methods of deploying the described intelligent building fixtures. Generally, four modes of deployment have been identified.

A first mode includes an installation mode. Fixtures are normally installed by electricians and certified installers. As each fixture is installed, it may be tested by powering it up and establishing communications with it. In the manual installation mode, each fixture responds independently with the fixture powered up and initialized or providing a recognizable wireless signal when powered up. In the case of the wireless damper fixture (and due to its above-ceiling challenge of access), the certified installer verifies communication with the damper fixture and the ability of changing its operation parameters.

A second mode includes a setup mode, entered once the installations are finished for the plurality of fixtures. Two types of setup are possible. A first setup type is automatic. In this mode, the fixtures would learn to communicate with each other. The first step would be for each fixture to identify itself to the other fixtures in close proximity. The fixtures would be interconnected via the wireless mesh network. Each fixture performs a function discernible to the adjacent fixtures. In this manner, a fixture becomes an addressable network node by other neighboring fixtures. It is possible to associate the address of a fixture with its physical location. Obstructions such as walls, metalwork, installed equipment and EMI (electromagnetic interference) above and below a ceiling would be mitigated through utilizing the robust and self-healing, re-routing network communications of a wireless mesh network.

Once a fixture or a plurality of fixtures is autonomously recognized, it can later be tagged and associated with a fixture type, such as a thermostat, by a tracking system or a system administrator (in cases where clarification or adjustment is needed).

A second setup type is manual, whereby the administrator has complete control of the setup process. Manual identification of a plurality of fixtures would be performed by a system administrator. First, the administrator identifies a fixture based on the identifying characteristics of the device (such as a QR code). The administrator would then add each fixture and its type into a tracking system. The administrator would assign a fixture identifier and designation to control it. When the administrator has finished the setup of the fixtures, the process is allowed to progress to the operational mode.

A third mode includes an operational mode. Fixtures perform as a unit in the operational mode. The fixtures previously set up respond to activity or controls such as thermostats. In the operational mode, the fixtures execute software that has been previously selected by the administrator or downloaded from an external source. This software allows the fixtures to change operating characteristics as specified by the system or an administrator. For example, the system or an administrator commands a selected wireless damper fixture (or a group of fixtures comprising a logical grouping) to adjust the air flow. The operational mode also provides for simple additions or replacement of fixtures. Major changes can require the system to enter a teardown mode.

A fourth mode includes a teardown mode. The teardown mode is used when major troubleshooting, repair or changes of a plurality of fixtures are needed. The teardown mode restores the system to the installation mode. In that mode, the fixtures can be modified and made ready for setup.

Embodiments of the building control systems include building fixtures that are networked in order for the fixtures to communicate that they are part of a data network. The network can be a typical wired or wireless LAN. The network can also be a specialized network such as a wireless Ad-Hoc mesh network as employed by an end-point wireless damper fixture, or another type of wireless network. Each networked fixture shall have unique network identification when manufactured which would be used during setup and operation to identify the fixture.

Referring back to FIG. 1, at least one of the building control fixtures (180) is interfaced with a sensor 184. However, another embodiment includes the sensor being physically incorporated Into at least one of the building fixtures, as is the case with an end-point wireless damper able to measure air flow and damper position.

Various configurations of the sensor include an environment sensor (such as a temperature or humidity sensor). It is to be understood that each sensor can include one of a different type of sensor, or any combination of different types of sensors. Other possible types of sensors include, for example, a motion or proximity sensor, light detection sensor, various gas sensors and/or a voltage/current/power monitoring sensor.

For at least some embodiments of the building control system of FIG. 1, the building control fixtures 130, 140, 150, 170, 180, 190 are independently operable. That is, each of the fixtures can operate completely independently, and the controller within each fixture is operable without receiving any commands from a central controller (such as Master Control Fixture 110). For other embodiments, the fixtures operate In conjunction with other fixtures, such as, other fixtures within a logical group (typically controlled by Local Group Control Fixtures 120, 160). For this embodiment, decisions regarding building control can involve a collaborative interaction between multiple fixtures. For other embodiments, one or more fixtures are interfaced with a system controller.

For an embodiment, each end point control fixture controller 131, 141, 151, 181, 191 independently control an environmental load or a HVAC device through an environmental control interface 133, 143, 153, 183, 193. More specifically, the controller controls at least one of an environmental control, fire control, or a building security control. As will be described, the building control fixtures can include HVAC air flow regulation (that is, an air flow damper included with the fixture), and the controller of the fixture controls the amount of air flow passing through an end point duct. Alternatively or additionally, the fixture can include environment control, such as, temperature or building zone air flow. For this embodiment, the fixture can be interfaced or be a part of an HVAC system. Alternatively or additionally, the fixture can interface with or be a part of a building fire control system.

For at least some embodiments of the building control system of FIG. 1, the building control fixtures 120, 160, sufficing as controlling an autonomous building zone (or logical group) can optionally control an environmental load or a HVAC device through an environmental control interface 133, be equipped with sensors 134 or integrate into the building control system (or BMS) 173. Additionally, the master control fixture 110 may also be integrated into the building control system (or BMS 190) through a wired or wireless communication port 112.

For embodiments, the state information includes, for example, damper position information, air flow rate, HVAC system temperatures.

A fixture may control, for example, air flow measured from the fixture based at least in part on a sensed parameter from another fixture of the logical group. A fixture may control air flow based on temperature or humidity sensing of other fixtures within the logical group. A fixture may make fire control decisions based on parameters sensed by other fixtures of the logical group.

A factor that greatly adds to the intelligence of the distributed building control fixtures are the designations of logical groups, wherein building fixtures of a logical group control building parameters based on sensed input from other building control fixtures of the logical group.

For an embodiment, an administrator specifies which of the plurality of building fixtures belong to the logical group. Generally, the administrator specification occurs at installation, and may remain static. Specifically, in the case of wireless damper installations, the administrator specifies logical groups based on HVAC zones. For another embodiment, a manual operator specifies which of the plurality of building fixtures belong to the logical group. This can include the operator having a manual control (such as an open door sensor or a set of door sensors) that allows the manual operator to set and control logical groupings. For example, in the case of a logical group as defined by a building's HVAC zone typically spanning a section of a floor within a building, the local group control fixture assumes the role of primary controller for all HVAC zones related to respective logical groups. Typically this role is assigned by an administrator user.

For an embodiment, the controller within a building control fixture is operative to help designate one or more of the plurality of building fixtures as belonging to a logical group. That is, the fixtures operate in conjunction with other fixtures, such as, other fixtures within a common logical group. For this embodiment, decisions regarding building control within the local group can involve a collaborative interaction between multiple fixtures, in which one of the fixtures suffice as a local group control fixture (that is, have the ability to communicate with the building management system network). For example, this dynamically assigned local group can function as a local group incorporating a backup local group control fixture 170.

For an embodiment, fixtures autonomously designate logical groups based on location and/or proximity. Proximity is determined by measuring the received signal strength of neighboring fixtures, whereby close proximity is determined by a configured signal strength threshold and proximity to a local group control fixture.

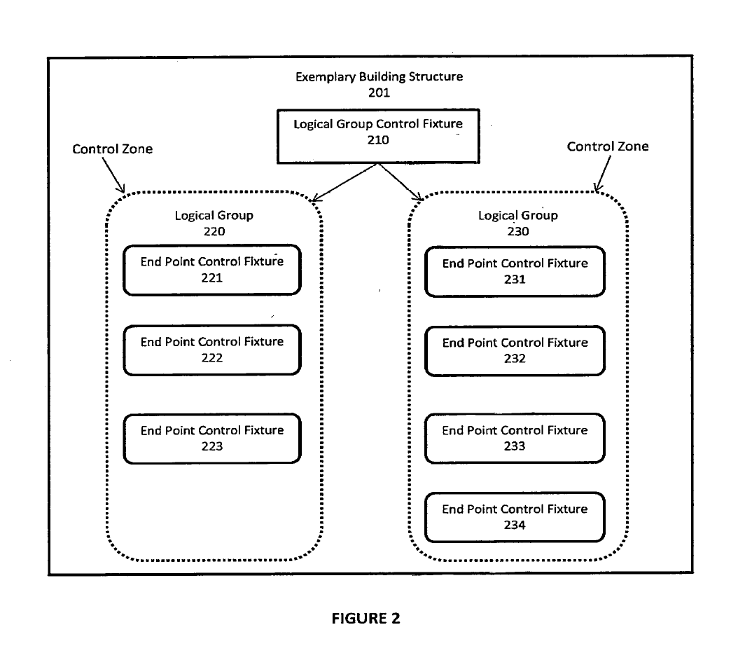

FIG. 2 shows an example of groups of fixtures within logical groups 210, 220 in building structure 201. Also as shown, a logical group is considered its own autonomous control zone and is managed by at least one local group control fixture 210 (there are possibly zero or many stand-by local group control fixtures). For example, an administrator-assigned local group 220 represents an HVAC zone having end point control fixtures 221, 222, 223 while local group 230 having end point control fixtures 231,232, 233, 234 represents a (non administrator-assigned) autonomous grouping based on proximity to a logical group control fixture (that may possibly overlap with other administrator-assigned or autonomously-assigned local groups).

Various embodiments include different types of logical groups. Exemplary logical group types include, for example, a HVAC zone group (previously mentioned), fire control group, a logical temperature group, and a logical open door sensor group. Clearly, additional types of logical groups can additionally or alternatively exist. Additionally, a building fixture can belong to any number of different logical groups. Logical groupings of building fixtures is useful for synchronizing members of logical groups, normalizing behavior based on larger samples of data, and/or making better decision based on larger sample of data. Additionally, a fixture being able to belong to any number of different groups is difficult and expensive in centrally controlled systems. As the membership list of fixtures in a centrally controlled system grows, the data that the controller must manage grows, which causes scaling problems. Amelioration of this scaling challenge is accomplished through the employment and deployment of a plurality of local group control fixtures (as mentioned, also providing for mitigation of a single point of failure).

An exemplary open door sensing group can be utilized, for example, by wireless damper fixtures located in a HVAC zone communicating with the door fixtures. For an embodiment, building fixtures of a zone determining they are in a zone, and autonomously designate themselves to be included within a common logical group (that is, the zone controlling group). Further, the zone controlling group includes a plurality of overlapping logical groups of building fixtures providing informational state information (such as temperature and/or humidity) aiding efficient control of a zone.

For the open door group, an embodiment includes at least a subset of the plurality of building fixtures designated to be within an open door group that, for example, collaborates as a fire access restriction mechanism. This logical grouping may contain one or a plurality of wireless dampers that are contained within other logical groupings.

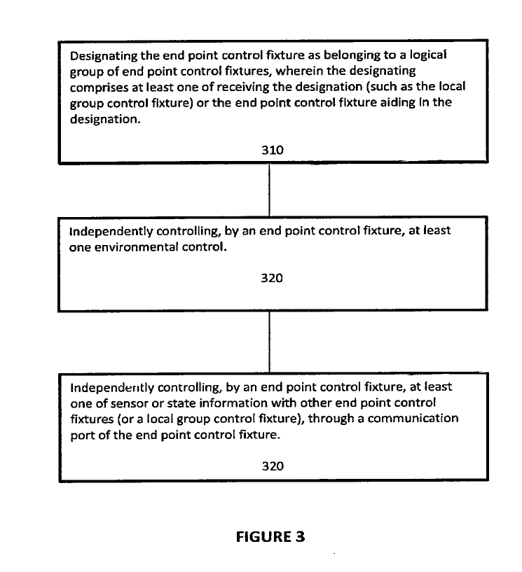

FIG. 3 is a flow chart that includes steps of an example of a method of operating a building control fixture according to an embodiment. A first step 310 includes designating the building fixture as belonging to a logical group of building fixtures, wherein the designating comprises at least one of receiving the designation or the building fixture aiding in the designation. A second step 320 includes independently controlling, by the building control fixture, at least one of an environmental load or a safety device. A third step 330 includes sharing, by the building control fixture, at least one of sensor or state information with other building fixtures within the logical group of building fixtures, through a communication port of the building control fixture.

As previously described, an embodiment further comprising the building control fixture receiving a sensor input, wherein the sensor input includes at least one of air flow or another environmental condition. This embodiment aggregates sensor and monitoring data and disseminates control commands through a hierarchy of building and replicated local group controllers.

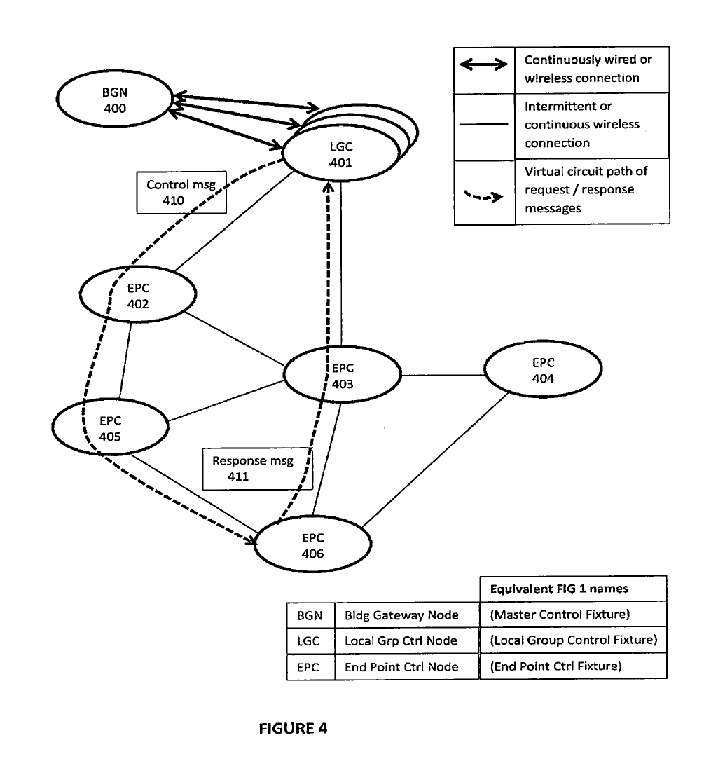

FIG. 4 is a diagram of a simple wireless mesh network employed by the present invention. This figure depicts the propagation of an environmental control message from a logical group control node (LOC) 401 to its targeted end point control node (EPC) 406. This figure also shows a possible network response message return path. This path and other paths can also be used by an originating sensor or monitoring message from an end point controller 402, 403, 404, 405, or 406 to a targeted logical group controller or another end point controller. The eventual network path and the number of nodes traversed are determined by the network protocol, the type of the message and what controller or Internet agent can process it and the transmission quality. Initiating messages and responses can be between end point controllers, logical group controllers or routed through the building gateway node (BGN) 400 to or from the internet. Autonomous response handling and control intelligence can be embedded in the building gateway node (BGN) 400, the logical group controllers (LGC) 401 or any of the end point controllers (EPC) 402-406, or originate from or to an internet agent using the building gateway node (BGN) 400 and the wireless mesh network.

This diagram shows missing connectivity between LGC 401 and EPC 404 due to a possible RF propagation impediment (such as an impervious structural member). The mesh network provides redundant network path compensation to remediate these types of environmental barriers.

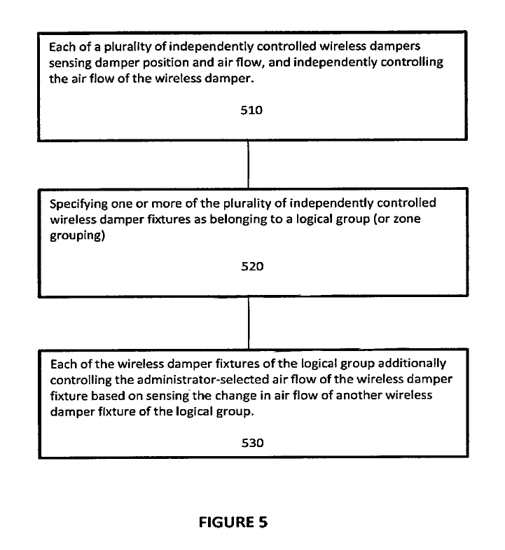

FIG. 5 is a flow chart that as an example is describing the autonomic air balancing feature of a HVAC zone 510. This embodiment relies on pre-set air flow configurations for each wireless damper and communication between each end point control fixture controlling and monitoring a wireless damper with its neighboring end point control fixtures within a logical control group 520 (that is either autonomously or administratively configured).

In this embodiment, a change in supply air flow or end point air flow shall cause those end point control fixtures controlling and monitoring a wireless damper to provide air flow compensation to achieve the appropriate air balancing 530.

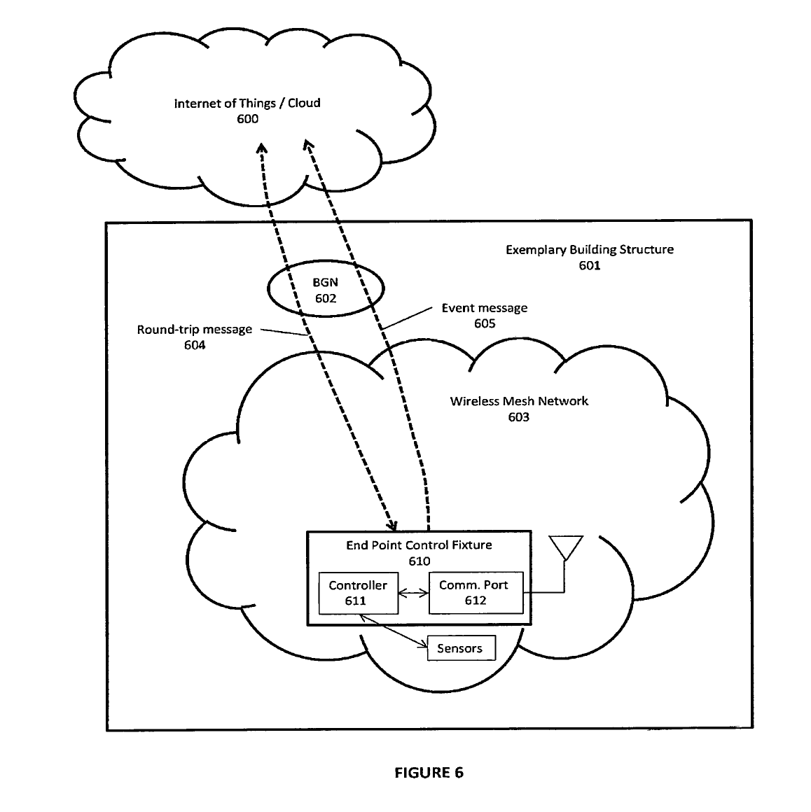

FIG. 6 is an overview diagram of sensing, monitoring, control aid response of an end point control fixture 610 utilizing the IoT cloud 600 and a building's wireless mesh network as described in FIG. 4 in this invention. This figure depicts the round trip propagation of an environmental control message 604 from the cloud 600 to its end point control fixture (EPC) 610 via a plurality of end point control fixtures that comprise the building's wireless mesh network 603. Additionally, this figure depicts end point control fixture 610 initiating communication through the wireless mesh network 603 for purposes of sending event information 605 to a recipient internet receiving agent, either within the wireless mesh network 603 or remotely across the IoT cloud 600.

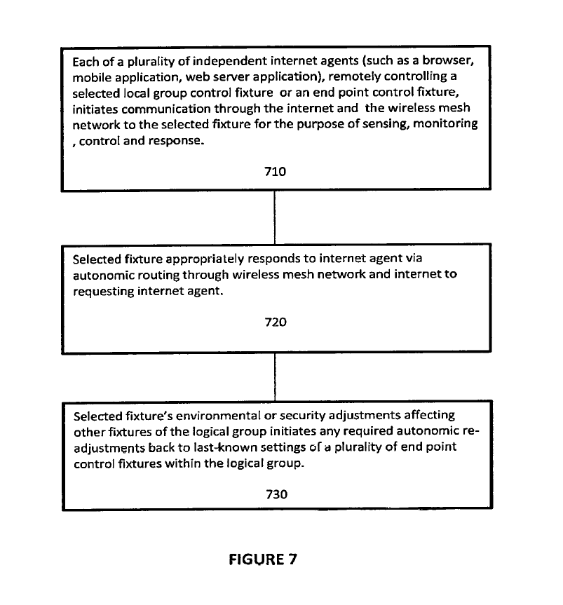

FIG. 7 is a flow chart that includes steps of a method for origination via internet agent(s) the remote control of a targeted logical group control fixture or end point control fixture routed through the wireless damper-based mesh network 710, 720. The final end point control fixture recipient initiates any environmental or security adjustments that may also affect other end point control fixtures within a local control group, whereby those fixtures initiate a group-collective compensation 730.

This embodiment also details scenarios where a plurality of end point control fixtures are command to adjust; and whereby other end point control fixtures within the logical control group autonomously compensate as well (730).

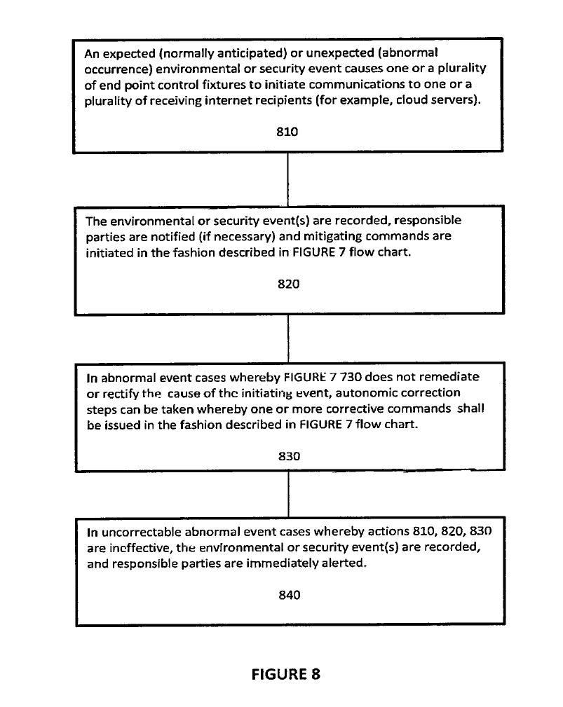

FIG. 8 is a flow chart that includes steps of a method for handling expected (normal), exceptional or abnormal situations according to an embodiment. A first step 810 includes a plurality of independently controlled end point control fixtures initiating communications to one or a plurality of recipient internet agents (either neighboring end point control fixtures within a local control group or internet agents external to the building). Steps 820, 830 describe autonomous processing of normal or abnormal events constituting mitigation controls, event recordation and notification to appropriate internet agents or recipient persons.

In cases where environmental or security event abnormalities cannot be mitigated or rectified, additional recordation and alerting to responsible parties is initiated. For example, out of tolerance temperatures sensed by one or a plurality of end point control fixtures initiates abnormal event communications to recipient internet agents and responsible parties.

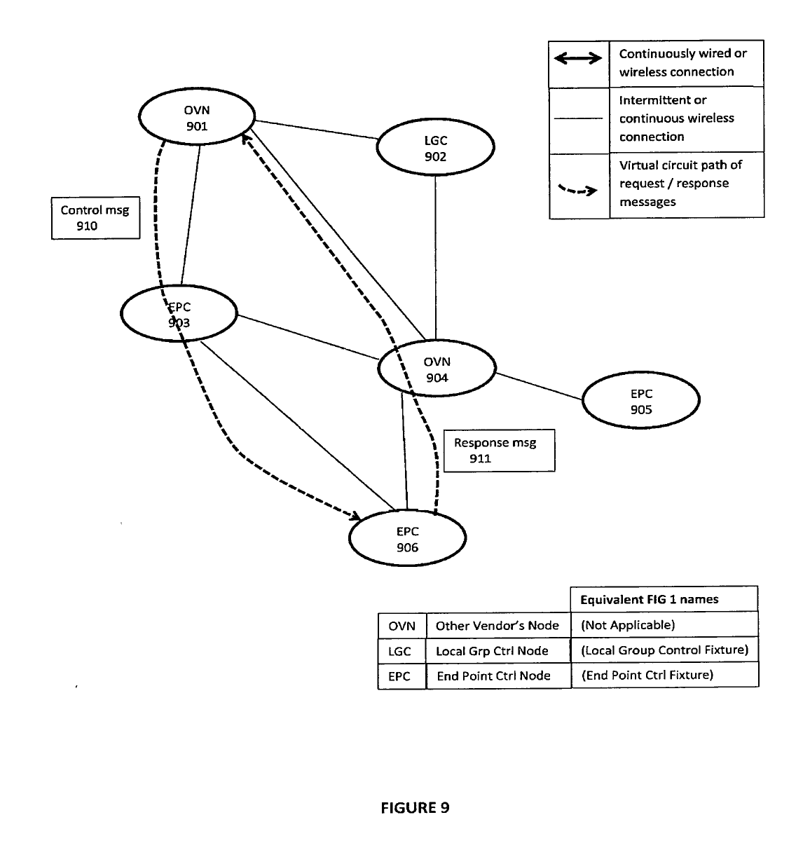

FIG. 9 is a diagram of a heterogeneous wireless mesh network employed by the present invention. This figure depicts the propagation of an environmental control message (910) from a third party vendor node (OVN) 901 to its targeted end point control node (EPC) 906. This figure also shows a possible network message return path. This path and other paths can also be used by an originating sensor or monitoring message from an end point controller 902, 903, 904, 905, or 906 to a targeted logical group controller, end point controller, or another third party node. The eventual network path and the number of nodes traversed are determined by the network protocol, the type of the message and what controller or internet agent can process it and the transmission quality. Initiating messages and responses can be between end point controllers, third party nodes, logical group controllers and possibly routed through a building gateway node (not shown) to or from the Internet. Autonomous response handling and control intelligence can be embedded externally on the Internet, the logical group controller (LGC) 902, third party controllers (901, 904) or any of the end point controllers (EPC) 902,903,905,906, or originate from or to an external internet agent using the heterogeneous wireless mesh network.

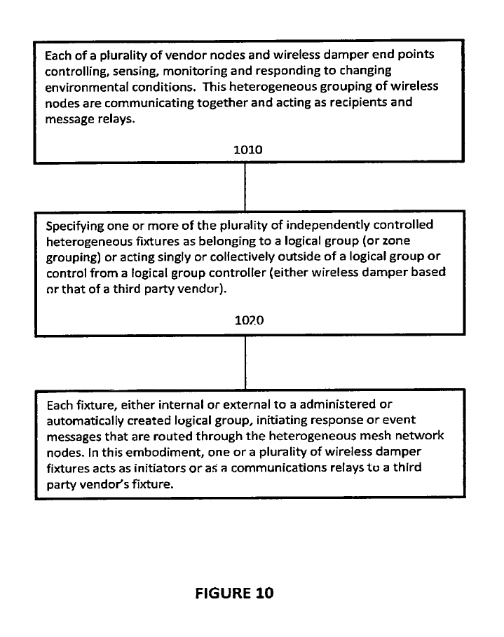

FIG. 10 is a flow chart that includes steps of a method for incorporating wireless damper nodes and those of other vendors in a heterogeneous wireless mesh network (1010) for the purpose of relaying bidirectional messages between each node, to a logical control group, to other logical control groups or the internet cloud. Command or message origination can be via a wireless damper node or any communication-compatible third parry vendor fixture (1020) routed through the heterogeneous mesh network (1030) with or without the benefit of a logical control group. The final end point control fixture recipient initiates any environmental or security adjustments or actions that may also affect other end point control fixtures within or outside of a local control group, whereby those fixtures initiate a group-collective or autonomic compensation.

1. A wireless damper functioning as mesh network access point, router and/or endpoints.

2. Single wireless damper control through mesh network

3. Control of multiple wireless dampers through a mesh network via a logical grouping.

4. A plurality of wireless dampers comprising the mesh network allows for network communications robustness in mitigating radio-based signal propagation degradation through the self-healing and re-routing nature of a wireless mesh network.

5. Using industry standard HVAC TAB (Test, Adjustment & Balancing) techniques to perform autonomous balancing in a logical grouping (for example, a HVAC zone)

6. A building floor-specific local group control fixture sufficing as a wireless mesh network access point.

7. For cases of additional resiliency, one or more secondary floor-specific local group control fixtures can be employed to serve as backup (or offloading network loads or enhancing the mesh network) access points for the primary floor-specific local group control fixture. This is decided either by the mesh node peer control fixtures or an administrator and is contingent on whether the control fixture has internet access to the building.

8. A building-level master control fixture sufficing as the aggregator for all floor-specific wireless mesh access points.

9. A building-specific master control fixture and a local group control fixture are similar to end point control fixtures with the exception of intended function and connectivity to a wireless damper.

10. All of these types of wireless dampers and wired control fixtures described above can be allowed to connect physically to or wirelessly to a building environmental, fire control or security fixture for the purposes of sensing, monitoring, controlling and responding to events on these fixtures.

11. All of these types of wireless dampers and wired control fixtures described above can be allowed to connect to and communicate with a building's management and automated systems (BMS and BAS, respectively) for the purposes of sensing, monitoring, controlling and responding to wireless damper fixtures throughout the building or a plurality of buildings.

12. IoT (Internet of Things) sensing, monitoring, controlling and responding thru mesh network to/from the internet external to a building or any other IoT fixtures within the building.

13. All wireless dampers can be configured to communicate with other vendor's IoT fixtures and act as an initiating or relaying controller or a recipient and responder of communications originating from said fixtures.

14. Sending an abnormal event message originating from an endpoint fixture or a plurality of local control group fixtures to a local group controller through the mesh network either to a local or remote internet recipient for fault rectification or mitigation purposes, and the capability of the endpoint fixture (or a plurality of local control group fixtures) to receive and act upon fault-mitigating commands.

15. OTA (Over the Air) wireless damper software updates for all control fixtures within a building.
